(19) United States
(12) Patent Application Publication
(10) Pub. No.: US 2025/0136261 A1
(43) Pub. Date: May 1, 2025

(54) INBOARD MARINE MOTOR DRIVE AND PROPULSION SYSTEM

(71) Applicant: ECOMAR PROPULSION LTD, Hampshire (GB)

(72) Inventors: Eugene Xavier BARI, Hampshire (GB); Angelito BARBIERTO, Hampshire (GB)

(21) Appl. No.: 18/836,739

(22) PCT Filed: Mar. 6, 2023
(86) PCT No.: PCT/IB2023/052074

§ 371 Date: Aug. 7, 2024

(30) Foreign Application Priority Data
Mar. 4, 2022 (GB) 2203041.5

(51) Int. Cl. B63H 23/02; B63H 21/38; B63H 23/34

(52) U.S. Cl. CPC B63H 23/02; B63H 21/383; B63H 23/34

(57) ABSTRACT

A marine motor drive comprises an even number (2N) of direct current (DC) electric axial flux motors. The 2N DC axial flux motors are connected along a common input axis to a gearbox. A drive shaft is connected from the gearbox along a drive shaft axis to a propeller. The drive shaft is perpendicular to the common input axis. An adjustment means enables repositioning the output drive shaft for alignment with an existing vessel propellor drive shaft. Ideally electric motors are located on opposite sides of the gearbox and a pump delivers coolant to each electric motor in a closed cycle.

### FIELD

The present invention relates to an electric powered marine motor drive and inboard propulsion system.

### BACKGROUND

Existing marine inboard propulsion systems are predominantly powered using the internal combustion engine, whilst, at time of writing, propellers powered directly from an electric motor drive system are rare due to the new emergence of the need for carbon reduction in the marine environment.

The system is designed to deal with the issues of integration into existing vessel design as a direct replacement of an internal combustion engine for propellor shaft power delivery and hull physical constraints whilst capable of operating in a harsh marine environment.

### PRIOR ART

United States patent application number US 2021/0119522 (CSAW Studios LLC) discloses a motor comprising a stator with a plurality of ferrous cores which is surrounded by a plurality of windings and a pair of rotors positioned on opposing sides of the stator. Each rotor includes a ring gear and a drive shaft that extends through a portion of the stator. The drive shaft has a pinion gear positioned at an end of the drive shaft in communication with the ring gears. The rotors rotate in opposing directions so that the ring gears translate a movement of the rotors to the drive shaft through the pinion gear, to rotate the drive shaft in a direction substantially orthogonal to a direction of rotation of the rotors.

Chinese utility model number CN 210246317U (Li Hongguang) discloses an electric ship propulsion system and an electric ship. The propulsion system comprises at least one yoke-free segmented armature axial flux permanent magnet generator and controller and an electricity storage device. At least one motor controller and a yoke-free segmented armature axial flux permanent magnet motor are also provided. By adopting the yoke-free segmented armature axial flux permanent magnet motor, the weight and size of the propulsion system is reduced.

Chinese utility model number CN 213139108U (ZHUHAI HANTUDA TECH CO LTD) discloses a contra-rotating paddle type annular electric propeller driven by an axial magnetic flux motor comprising a propeller unit. The contra-rotating paddle annular electric propeller is supported by bearings and driven by forward and rearward axial magnetic flux motors.

An axial magnetic flux motor is adapted to directly drive a contra-rotating propeller, thereby obviating intermediate transmission equipment. A rotor assembly and the propeller are supported by a shaft and a bearing is arranged in water for transmitting thrust to the ship.

Although satisfying specific needs in some sectors there is a need for an electrically driven marine motor drive which offers greater resilience, and which has greater efficiency.

More specifically vessels are susceptible to movements due to dynamic loading during voyages. These effects are exacerbated, for example by the keel protruding under water which transmits forces to the vessel. These forces can cause problems with steering as well as cause discomfort to occupants of the vessel. In addition the forces can cause inefficiency in the motor drive system as power is used to drive against the inertia in order to steer a correct course.

The invneiton arose in order to provide an electric drive system for a vessel and which overcomes the aforementioned problems.

### SUMMARY OF THE INVENTION

According to a first aspect of the present invention there is provided a marine motor drive comprises: 2N electric axial flux motors, each motor is connected along a common input axis, to a gearbox and a drive shaft is connected to the gearbox along a drive shaft axis which is perpendicular to the common input axis, where N is a positive integer.

The marine motor drive of the present invention comprises multiple axial flux, direct current (DC) motors rather than a single, large conventional radial AC motor. The use of axial flux motors has been found to provide efficient, high power with greater resilience in the event of a motor failure, so providing security whilst at sea.

The electric motors are preferably arranged in pairs.

Preferably, each electric motor, for example each electric motor within the or each pair of motors, is located on opposite sides of the gearbox.

The selection of the electric axial flux DC motor has also been found to provide maximum efficiency of use of stored energy from battery systems.

The axial flux DC motors and associated parts are mounted to a chassis in a configuration that allows ease of maintenance. In addition their configuration is built to appropriate ingress protection (IP) ratings in order to counter harsh conditions found in the hull of marine vessel. All electrical and hydraulic couplings are industry standard mechanisms which allow ease of maintenance and replacement of components.

The employment of multiple, smaller, direct current (DC) axial flux motor drives, rather than a conventional large, single radial drive motor, reduces effort and time of installation and maintenance by eliminating a requirement for heavy duty lifting equipment and the need to access a larger space because conventional large, single radial drive motor tended to have a larger ‘footprint’. The marine motor drive also provides operational resilience from motor redundancy so providing increased safety against a stranded vessel. For example should one motor fail, there is at least one further motor still available to provide propulsion, albeit at reduced power. This allows for a ‘limp home’ capability.

Another advantage is that the chassis and propellor shaft connection allow for installation adjustability and straightforward retrofit to many existing vessel designs as a direct replacement or an alternative to an internal combustion engine for new builds.

The gearbox and chassis design also allow for scalability by attaching additional pairs of motors to both the linear and perpendicular axes of the propellor shaft output, whilst gearbox and chassis physical size and components are scalable for different power output motors.

During operation, the perpendicular arrangement of each motor spindle axis, relative to the drive shaft of the marine motor drive, has been found to minimise gyroscopic moment inertia effects on vessel stability and hull vibrations. The modular scaling of the marine motor drive, to increase power with the use of separate sets of multiple motor configurations, is also resilient to distortional damage from natural hull flex, as indicated in FIG. 6 for example, of the power train and so reduces dynamic loading on bearings and connections and reduces a requirement to build additional strengthening into the motor mounting area of the hull.

The marine motor drive preferably further comprises at least one pump for delivering coolant to each electric motor.

In one embodiment N is 2 and the electric motors are arranged in two pairs.

The marine motor drive is preferably an inboard marine motor drive.

The marine motor drive may be secured to a chassis of a marine vessel in a manner that allows ease of maintenance whilst built to appropriate maritime standards water ingress protocol ratings to counter harsh conditions found in the hull of marine vessel.

The marine motor drive is preferably housed within a rigid frame chassis which is adapted to be secured to a vessel. The rigid frame chassis may be hinged to permit access to the motor drive and gearbox. In one embodiment, the marine motor drive may include at least one hydraulic ram which assists pivoting of the rigid frame chassis.

The rigid frame chassis is preferably configured for installation adjustability and simple retrofit to existing vessel designs as direct replacement or alternative to an internal combustion engine for new builds.

The marine motor drive may be configured to be adjustably positioned relative to the vessel to provide for correct alignment with the propellor shaft of the vessel.

In one embodiment, the marine motor drive, for example the rigid frame chassis, provides one or more slotted mounting openings for securement of the motor drive (for example rigid frame chassis) to a vessel. The one or more slotted mounting openings provide for fine positioning adjustment of the motor drive (for example rigid frame chassis) relative to the vessel to provide correct alignment with the propellor shaft of the vessel.

The marine motor drive is preferably configured with a means to provide rotational adjustment for aligning the output drive shaft with an existing vessel propellor drive shaft.

The gearbox and/or rigid frame chassis are preferably modular in nature which allows for scalability of the marine motor drive by enabling additional pairs of electric motors to be attached along the linear axis of the drive shaft.

The gearbox and/or rigid frame chassis are preferably scalable for use with different power rated motors. The gearbox may preferably comprise interchangeable gears configured for use with different gear ratio requirements.

The motor drive may comprise a removable flange and an adaptor for connecting to enable connection to a compatible propellor shaft.

Preferably, the motor drive has a reversible motor connection. One or more, preferably each, of the axial flux motors may be configured to be physically reversible, in their respective mountings. This is in part enabled by their one or more connections for coolant, power and/or control.

Selection of the DC motor allows maximum efficiency of use of stored energy from battery and/or other types of energy storage systems.

The motor drive preferably has a vibration/resonance/balance for improved vessel control, stability and comfort.

The opposed 2N electric motors and their plane of axial rotation relative to the plane of axial rotation of the output drive shaft are preferably configured to minimise the gyroscopic effect by way of balancing of these effects with respect to one other.

The plane of axial rotation of the motors is perpendicular to the plane of axial rotation of the drive shaft. As such, the plane of axial rotation of the motors is preferably arranged at 90 degrees from the rotational direction of a hull of the vessel. The marine motor drive has been found to reduce, and preferably eliminate, the motion effects of roll, yaw and sway that were previously suffered by existing marine motor systems.

The invention therefore reduces the so-called ‘stacked’ rotational effects which existing marine motors imposed on the vessel, thereby reducing these to below acceptable, safe limits.

The present invention will now be described, by way of example only, and with reference to the following drawings in which:

### BRIEF DESCRIPTION OF THE FIGURES

FIG. 1 is a schematic illustration of a perspective view of one embodiment of the marine a motor drive of the present invention where N is 1;

FIG. 2 is a schematic illustration of a perspective view of a further embodiment of the marine motor drive, where N is 2 and the two pairs of electric motors are connected one to another in-line, showing modularity, and also connected to a drive shaft with propellor attached;

FIG. 3 is a schematic illustration of the motion effects of a conventional motor drive system upon the hull of a vessel;

FIG. 4 is a schematic illustration of the reduced motion effects achieved by the use of the marine motor drive system upon the hull of a vessel;

FIG. 5 is a schematic illustration of an output drive shaft coupling showing flex or play within a coupling which accommodates alignment errors with the propellor drive shaft and flexes when the hull deflects under motion;

FIG. 6 is a diagram representing a vessel when berthed and waterborne with a conventional motor drive system installed and shows how it reduces effects of hull twist on the drive train;

FIG. 7A and 7B are diagrams representing a vessel at berth and waterborne with the marine motor drive installed and shows how it reduces effects of hull twist on the drive train;

FIG. 8 is a schematic illustration of an embodiment of the marine motor drive illustrating how an adjustable positioning of the gearbox provides incremental radial positioning of the output drive shaft; and

FIG. 9 is a schematic illustration of an embodiment of the marine motor drive and illustrates an individual motor orientation and motor couplings for electrical and coolant supplies.

### DETAILED DESCRIPTION OF PREFERRED EMBODIMENT OF THE INVENTION

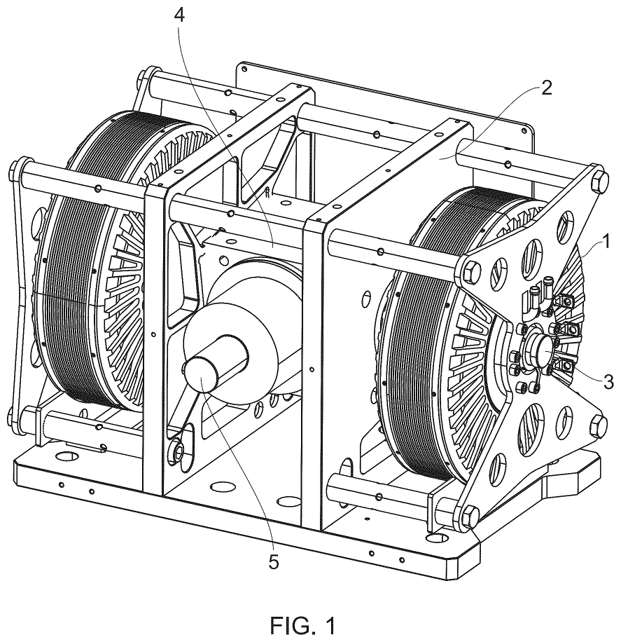

With reference to FIG. 1, the marine motor drive of the present invention comprises a pair (N is 1) of directly opposed electric axial flux DC motors 1 secured to a rigid frame chassis 2. The pair of axial flux motors 1 are positioned such that the output shafts of the motors 1 are aligned along a common axis 3. The DC motors 1 are configured to be connected directly to drive a gearbox 4. The gearbox 4 is located between the DC motors 1 and is also secured to the rigid frame chassis 2. The gearbox 4 has a drive output shaft 5 extending perpendicular to the common input axis 3.

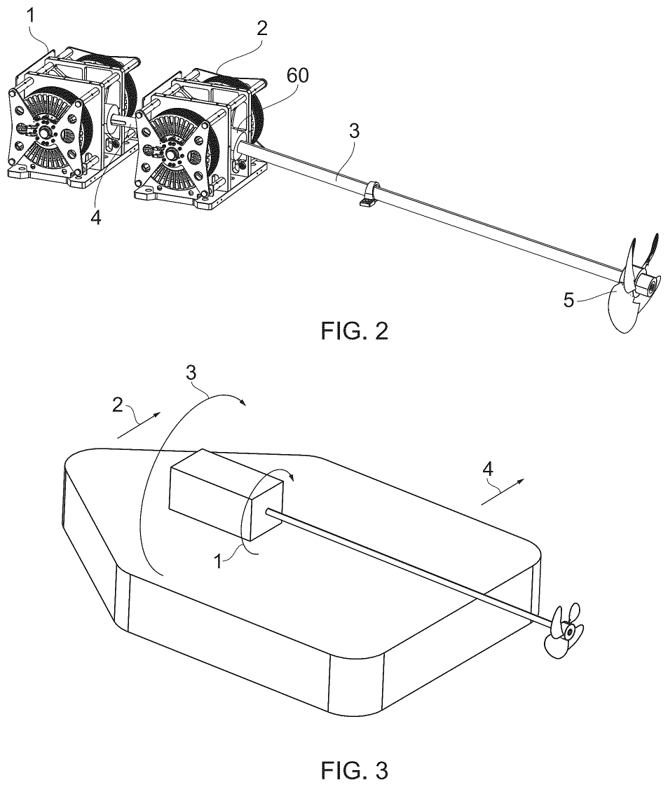

As shown in FIG. 2, according to one embodiment of the present invention, the marine DC motor drive comprises two pairs of electric axial flux motors (N is 2). The electric motors 1, 1′ are coupled together along a common input axis 6 extending between the drive output shaft 5 of the gearbox of the first DC electric motor 1 and a rear input shaft of the second electric motor 1′. The marine motor drive system is further equipped with a propellor 7 profile modelled to suit the need of vessel operational requirements and the power characteristics of the selected motor drive system. The propellor 7 is connected to the drive shaft 5′ of the second electric motor 1′.

It is to be understood that the DC marine motor drive of the present invention may comprise any suitable numbers of pairs of electric axial flux motors (N may be any suitable positive integer); therefore it is not to be limited to two electric axial flux motors. The DC motor drive preferably allows for scalability by enabling additional pairs of electric motors to be attached along the linear axis of the drive shaft. Multiple pairs of electric axial flux motors 1, and rigid frame chassis 2, may be coupled together along the rotational axis of the drive output shaft 5 thereby providing a modular capability to increase system power. To facilitate this modular capability, each motor ideally includes connections for coolant conduits and/or power lines and/or control lines, so as to facilitate their rapid removal from a chassis thereby simplifying their replacement and repair.

It is further understood that the gearbox 4 (as shown in FIG. 1) of the, or each, marine motor drive 1, 1′ can be fitted with different gear ratio changes to suit specific operational requirements for motor power and rotational propellor speed fora vessel. The gearbox may preferably comprise interchangeable gears that are configured for use with different gear ratio requirements. A user is therefore able to select the appropriate gear ratio for a gearbox of each motor drive for a particular vessel depending on the specific workload parameters and other requirements.

The rigid frame chassis 2 is configured for installation adjustability and simple retrofit to existing vessel designs as direct replacement or alternative to an internal combustion engine for new builds. The marine motor drive 1 is configured to be adjustably positioned relative to the vessel to provide for correct alignment with the propellor shaft of the vessel. The rigid frame chassis 2 of the motor drive 1, 1′ may employ one or more slotted mounting location holes to allow for accurate alignment of the motor drive with the propellor shaft.

The one or more slotted mounting openings provide for fine positioning adjustment of the motor drive (for example rigid frame chassis) relative to the vessel to provide correct alignment with the propellor shaft of the vessel. It is also to be understood that the marine motor drive may be configured to provide rotational adjustment capability for aligning the output drive shaft with an existing vessel propellor drive shaft.

It is to be understood that in some embodiments the rigid frame chassis may be hinged to permit user access to the motor drive and gearbox. The marine motor drive may for example include at least one hydraulic ram which assists pivoting of the rigid frame chassis about such a hinge.

The motor drive of the present invention provides vibration/resonance/balance for improved boat control, stability and comfort. The opposed 2N electric motors and their plane of axial rotation relative to the plane of axial rotation of the output drive shaft are configured to minimise the gyroscopic effect by way of balancing of the effect to each other and being arranged at 90 degrees from the rotational direction (port/starboard direction) of a hull of the vessel. The marine motor drive of the present invention has also been found to reduce the motion effects of roll, yaw and sway.

As shown in FIG. 3, the layout configuration of a conventional axial flux motor creates undesirable motion effects on a vessel. The conventional configurations build significant moments of inertia which are transferred to the vessel. Due to the vessel floating on water and not being a fixed point, the inertia energy is transferred to vessel movement defined by the nautical definitions of Yaw 10, Roll 11 and Sway 12.

A vessel is susceptible to movements in the port to starboard plane due to the relatively narrow dimensions in relation to a fore and an aft plane whilst these effects are exacerbated by the keel protruding under the water to aid in the transfer of the energy. These movements cause steering issues for the vessel, create discomfort to occupants of the vessel, and inefficiency in the motor drive system as power is used to drive against the inertia to steer in the correct direction.

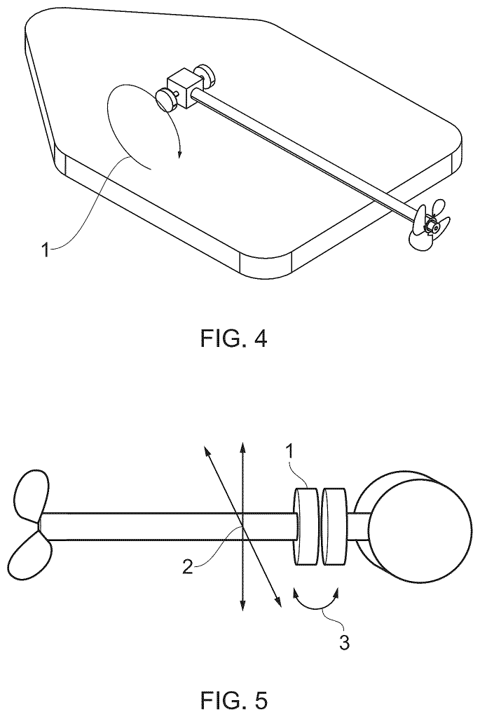

As shown in FIG. 4, the marine motor drive of the present invention has been found to minimise the moments of inertia described as being produced by the use of the conventional motor as shown in FIG. 3. The moments of inertia created by the marine motor drive of the present invention have been found to be significantly reduced, compared to conventional systems, as a result of using multiple, smaller motors rather than a single, larger motor.

Furthermore, the positioning of the marine motor drive of the present invention delivers any moments of inertia built from rotation of the motors into the fore/aft axis 13 of the vessel thus eliminating its movement effects on Sway, Roll and Yaw. The moments of inertia created by rotation of the motor drive 1 of the present invention are perpendicular to moments of inertia created by the conventional system shown in FIG. 3.

The moments of inertia created by the motor drive 1 of the present invention are absorbed due to the inherent stability of the vessel from its own mass in this axis and as a result minimising, preferably eliminating, movement effects of sway, roll and yaw. The present invention therefore reduces steering issues for the vessel, reduces discomfort to occupants of the vessel, and improves efficiency in the motor drive system as power is not being used to drive against the inertia to steer in the correct direction.

As shown in FIG. 2, two pairs of motor drive systems employs flexible shaft couplings 60 between drive shaft 6 and propellor shaft 3 and between motor drive systems which are coupled as pairs. This further reduces the so-called hull defection which can impose stresses to the motor drive assembly, whilst also enabling management of minor misalignment of motor drive system mountings in relation to the propellor shaft 3.

Couplings also reduce hull deflection induced stresses which may be imposed by a propeller shaft in a non-operational plane. Additionally the configuration has been found to reduce transmission of vibration forces and so-called tail whip which can occur from a deflected hull and if there is propeller shaft misalignment. The coupling 60 is adaptable for various propellor shaft sizes and or existing couplings.

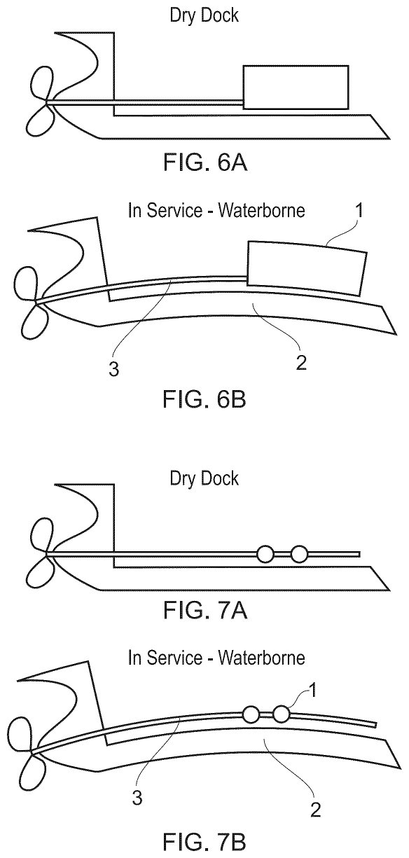

As shown described in FIGS. 6A, 6B, 7A and 7B, the present invention minimises wear and failure of system components potentially caused by natural hull flex of a waterborne vessel. FIGS. 6A and 6B show two diagrammatical images of a conventional axial flux motor 20 within the hull of a vessel. FIG. 6A is an illustration of a conventional motor 20 in dry dock when the hull is in its natural straight form including the propellor shaft and the shaft of the motor.

FIG. 6B is an illustration of the flex in the hull of a waterborne vessel and the subsequent flex on the propellor shaft and the motor shaft of motor 20. This flexing causes premature wear and failure of motor components (not shown) where previously, typically heavy-duty motor casing, bearings and mountings are employed to minimise damage.

FIGS. 7A and 7B show two diagrammatical images of the marine motor drive of the present invention within the hull of a vessel. FIG. 7A is an illustration of the marine motor drive of the present invention in dry dock when the hull is in its natural straight form including the propellor shaft and the shaft of the motor. FIG. 7B is an illustration of the flex in the hull of a waterborne vessel and the subsequent flex on the propellor shaft 3 and the motors 1 of the marine motor drive of the present invention.

The motors 1 of the present invention are located on a separate drive shaft that extends perpendicular to the propellor shaft. As a result, the stresses experienced as a result of flex are near eliminated. The length of the gearbox 4 is minimal so that bending effects imposed by movement in the hull are minimal and is sufficiently short that the effects of hull flex are negligible. The requirements for oversized motor casings, bearings and mountings of a of a conventional single, large motor drive unit (not shown) are therefore advantageously eliminated.

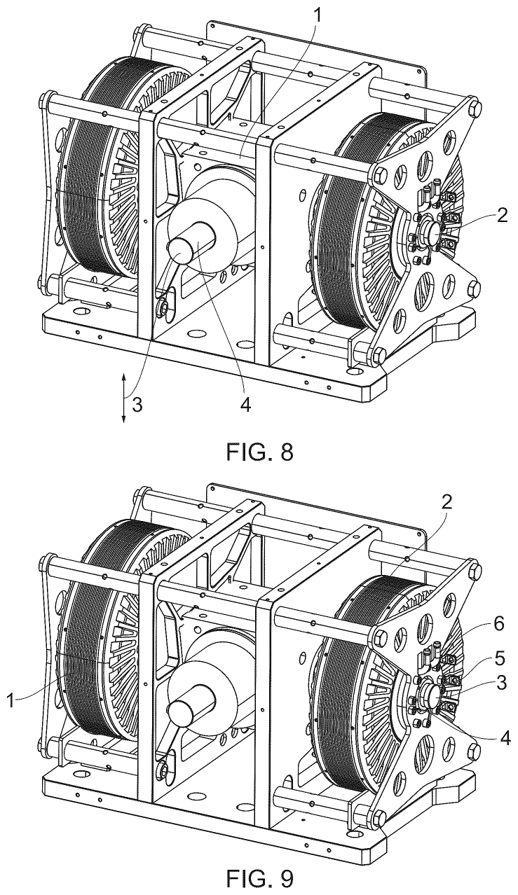

As illustrated in FIGS. 8 and 9, the gearbox 4 can be rotated about the common input axis 3 to provide pivotal radial positioning 8 of the output drive shaft 5 which allows for accurate alignment to varying a drive shaft seated linear propellor angle of a vessel.

Referring to FIG. 9, the opposed motors 1 and 2 at either end of the input axis 3 to the gearbox 4 are reversed on their axis of rotation to allow ease of access to supply connections for controls 9A, DC power 9B, and coolant 9C. Motors 1 and 2 are required to rotate in opposite directions for system function.

The invention has been described by way of examples only, and it will be appreciated that variation may be made to the aforementioned embodiments without departing from the scope of protection as defined by the claims.

1. A marine motor drive comprises: 2N electric axial flux motors, each motor is connected along a common input axis, to a gearbox and a drive shaft is connected to the gearbox along a drive shaft axis which is perpendicular to the common input axis, where N is a positive integer.

2. The motor drive according to claim 1 wherein each electric motor is located on opposite sides of the gearbox.

3. The motor drive according to claim 1 includes at least one pump for delivering coolant to each electric motor.

4. The motor drive according to claim 1 wherein N=2, and additional pairs of electric motors are connected one to another by way of the output drive shaft of the gearbox is connected to the rear of the adjacent gearbox along the drive shaft axis.

5. The motor drive according to claim 1 is adapted to be received in, and connected to, mountings in a rigid frame chassis as an inboard marine motor drive.

6. The motor drive according to claim 5 wherein the rigid frame chassis is adapted to be secured to a vessel.

7. The motor drive according to claim 5 wherein a pair of motors is adapted to be reversible in their respective mountings.

8. The motor drive according to claim 1 wherein the motors include connections for coolant conduits and/or power lines and/or control lines.

9. The motor drive according to claim 1 wherein an adjustment means is provided for aligning the gearbox and propellor shaft.

10. The motor drive according to claim 5 wherein slotted mounting holes, in the rigid frame chassis, allow fine positioning of the motor drive in a vessel, to enable improved alignment of the gearbox and the propellor shaft.

11. The motor drive according to claim 1 has an adaptor for connection to a propellor shaft.

12. The motor drive according to claim 1 wherein a gearbox mechanism, which is adapted to connect to the gearbox, has interchangeable gears to suit different gear ratio requirements.

13. The motor drive according to claim 1 has a rotational adjustment means for repositioning the output drive shaft for alignment with an existing vessel propellor drive shaft.

14. The motor drive according to claim 1 has a balancing means for improving vessel control and/or vessel stability and/or vessel comfort, wherein the balancing means reduces gyroscopic coupling between a plane of axial rotation of pairs of opposed motors and a plane of axial rotation of the output drive shaft.

15. A vessel including the motor drive according to claim 1.
